(19) United States
(12) Patent Application Publication
(10) Pub. No.: US 2025/0383178 A1
(43) Pub. Date: Dec. 18, 2025

(54) DEPLOYMENT APPARATUS

(71) Applicant: THE DYNAMIC ENGINEERING SOLUTION PTY LTD, Holden Hill, South Australia (AU)

(72) Inventors: Phillip KUYS, Holden Hill (AU); Oscar FIORINOTTO, Holden Hill (AU)

(73) Assignee: THE DYNAMIC ENGINEERING SOLUTION PTY LTD, Holden Hill, South Australia (AU)

(21) Appl. No.: 19/107,940

(22) PCT Filed: Aug. 30, 2023
(86) PCT No.: PCT/AU2023/050838

§ 371 Date: Feb. 28, 2025

(30) Foreign Application Priority Data
Sep. 1, 2022 (AU) 2022902516

(51) Int. Cl. F41F 3/042

(52) U.S. Cl. CPC F41F 3/042

(57) ABSTRACT

A deployment apparatus comprising a deployment mechanism and a deployable module, wherein the deployable module is moveable between a stowed position within a housing and a deployed position at least partially outside the housing, wherein the deployment mechanism comprises independent lift and tilt arrangements, wherein the lift arrangement controls the elevation of the deployable module relative to the housing and the tilt arrangement controls the relative tilt angle of the deployable module relative to the housing.

### PRIORITY DOCUMENTS

The present application claims priority from Australian Provisional Patent Application No. 2022902516 titled “DEPLOYMENT APPARATUS” and filed on 1 Sep. 2022, the content of which is hereby incorporated by reference in its entirety.

### TECHNICAL FIELD

The present disclosure relates to a deployment apparatus.

### BACKGROUND

Military vehicles are often equipped with a variety of weapon and sensor systems, including missile launchers and camera pods.

It is desirable that such systems are able to be moved between a stowed position, at least partially encapsulated within the ballistic protection of the vehicle and a deployed position for use.

Such systems may also have transport or safety requirements, such as the need to isolate sensitive components from vibration and shock loading associated with transport, and the need to prevent unintended deployment of such systems.

It is against this background that the present disclosure has been developed.

### SUMMARY

According to a first aspect, there is provided a deployment apparatus comprising a deployment mechanism and a deployable module, wherein the deployable module is moveable between a stowed position within a housing and a deployed position at least partially outside the housing, wherein the deployment mechanism comprises independent lift and tilt arrangements, wherein the lift arrangement controls the elevation of the deployable module relative to the housing and the tilt arrangement controls the relative tilt angle of the deployable module relative to the housing.

In one form, the deployment mechanism further comprises a deployment member pivotally connected with respect to the housing and a first end pivotally connected with respect to the deployable module, wherein the lift arrangement is configured to adjust the angle of the deployment member between stowed and deployed positions with respect to the housing, such that in the stowed position, the deployment member is at a minimum angle and in the deployed position, the deployment member is at a maximum angle.

In one form, the lift arrangement comprises a first linear actuator, pivotally connected at its first end with respect to the housing, about an axis parallel to and spaced apart from that about which the deployment member is pivotally connected with respect to the housing, and pivotally connected at its second end with respect to the deployment member, such that retraction and extension of the first linear actuator causes a respective increase and decrease in the angle between the deployment member and the housing.

In one form, the tilt arrangement comprises a second linear actuator, pivotally connected at its first end with respect to the housing, about an axis parallel to and spaced apart from both the axis that the deployment member and first linear actuator rotate with respect to the housing, and pivotally connected at its second end with respect to the deployable module, about an axis parallel to and spaced apart from that about which the deployment member is pivotally connected with respect to the deployable module, such that retraction and extension of the second linear actuator causes a respective decrease and increase in the angle between the deployable module and the housing.

In one form, the deployable member comprises a rigid body and a damped body mounted with respect to the outer body by a damping arrangement configured to isolate the damped body from vibration and shock events.

In one form, the damping arrangement comprises a plurality of wire rope isolators separating the damped body from the rigid body.

In one form, the damping arrangement further comprises a plurality of damper bushings mounted with respect to the damped body and a plurality of shock pins mounted with respect to the rigid body, wherein in the event of a shock event, one or each of the bushings will engage a respective shock pin.

In one form, the damping arrangement further comprises a locking arrangement for the deployable module, the locking arrangement configured to selectively preload the damping arrangement by preloading each of the compliant bushings against their respective shock pins.

In one form, the locking arrangement is further configured to selectively prevent deployment of the deployable module from the housing.

In one form, the locking arrangement is configured to achieve two states, where in a first state, the deployment of the deployable module is prevented, and the damper is not preloaded, and in a second state, deployment of the deployable module is allowed and the damper is preloaded.

### BRIEF DESCRIPTION OF DRAWINGS

Embodiments of the present invention will be discussed with reference to the accompanying drawings wherein:

FIG. 1 is a perspective view of a deployment apparatus, according to an embodiment, in a stowed position;

FIG. 2 is a perspective view of the deployment apparatus of FIG. 1, in a deployed position with a portion of the housing removed to reveal internal components;

FIG. 3 is a side view of the deployment apparatus of FIG. 1, in a first partially deployed position with a portion of the housing removed to reveal internal components;

FIG. 4 is a side view of the deployment apparatus of FIG. 1, in a second partially deployed position with a portion of the housing removed to reveal internal components;

FIG. 5 is a side view of the deployment apparatus of FIG. 1, in a deployed position and at a first tilt angle;

FIG. 6 is a partial side view of the deployment apparatus of FIG. 1, in a deployed position and at a second tilt angle;

FIG. 7a is an isometric view of the deployable module of FIG. 1, where the combined travel and damper locking arrangement is in a first state;

FIG. 7b is an isometric view of the deployable module of FIG. 1, where the combined travel and damper locking arrangement is in a second state;

FIG. 8a is an isometric view of the deployable module of FIG. 1, with a portion of the outer housing of the deployable module removed to reveal the combined travel and damper locking arrangement in a first state;

FIG. 8b is an isometric view of the deployable module of FIG. 1, with a portion of the outer housing of the deployable module removed to reveal the combined travel and damper locking arrangement in a second state;

FIG. 9 is an isometric view of the deployment apparatus of FIG. 1, with a portion of the outer housing of the deployable module removed to reveal the combined travel and damper locking arrangement in a first state;

FIG. 10 is a detailed view of FIG. 9 revealing the interaction between the travel lock and the housing;

FIG. 11a is bottom view of a portion of the combined travel and damper locking arrangement, where the combined travel and damper locking arrangement is in a first state;

FIG. 11b is a bottom view of a portion of the combined travel and damper locking arrangement, where the combined travel and damper locking arrangement is in a second state;

FIG. 12a is a detailed view of FIG. 11a, revealing the mechanical linkage arrangement in its first state;

FIG. 12b is a detailed view of FIG. 11b, revealing the mechanical linkage arrangement in its second state;

FIG. 13a is a side view of the deployable module of FIG. 1, with a portion of the outer body removed to reveal the combined travel and damper locking arrangement in a first state;

FIG. 13b is a side view of the deployable module of FIG. 1, with a portion of the outer body removed to reveal the combined travel and damper locking arrangement in a first state;

FIG. 14a is a detailed view of FIG. 13a;

FIG. 14b is a detailed view of FIG. 13b;

FIG. 15a is a flowchart detailing the deployment process for the deployment apparatus; and

FIG. 15b is a flowchart detailing the stowing process for the deployment apparatus.

### DESCRIPTION OF EMBODIMENTS

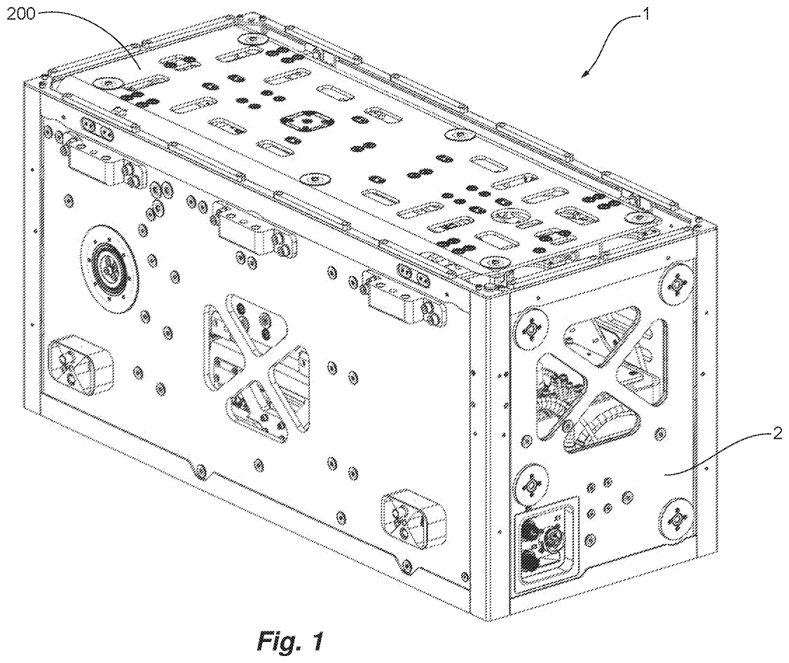

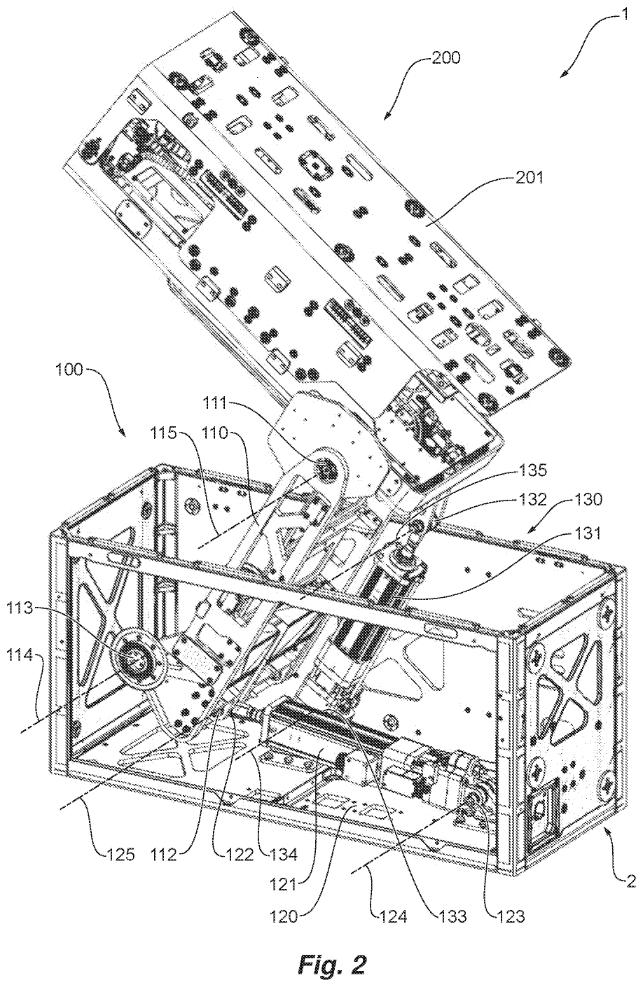

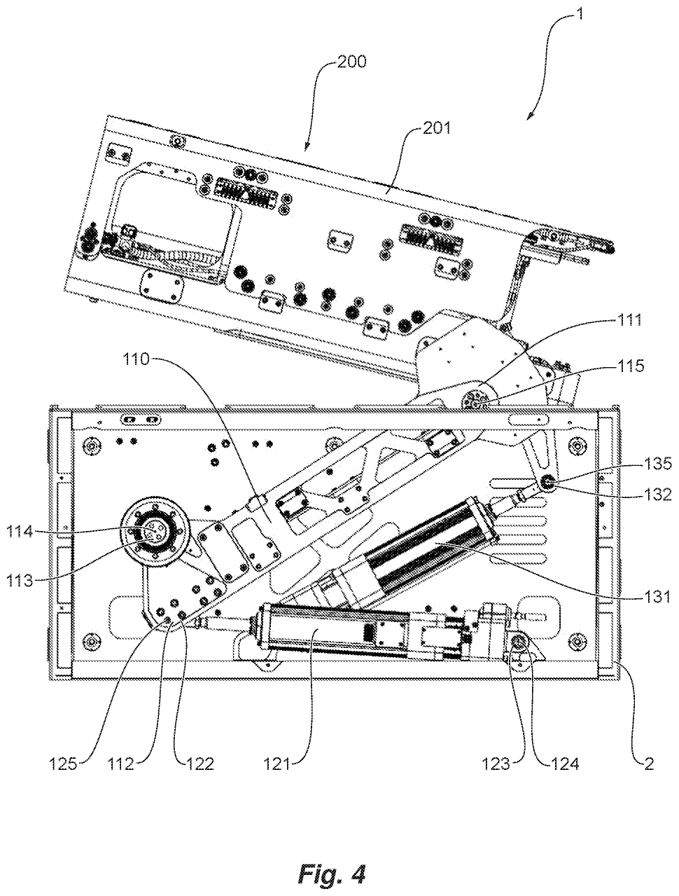

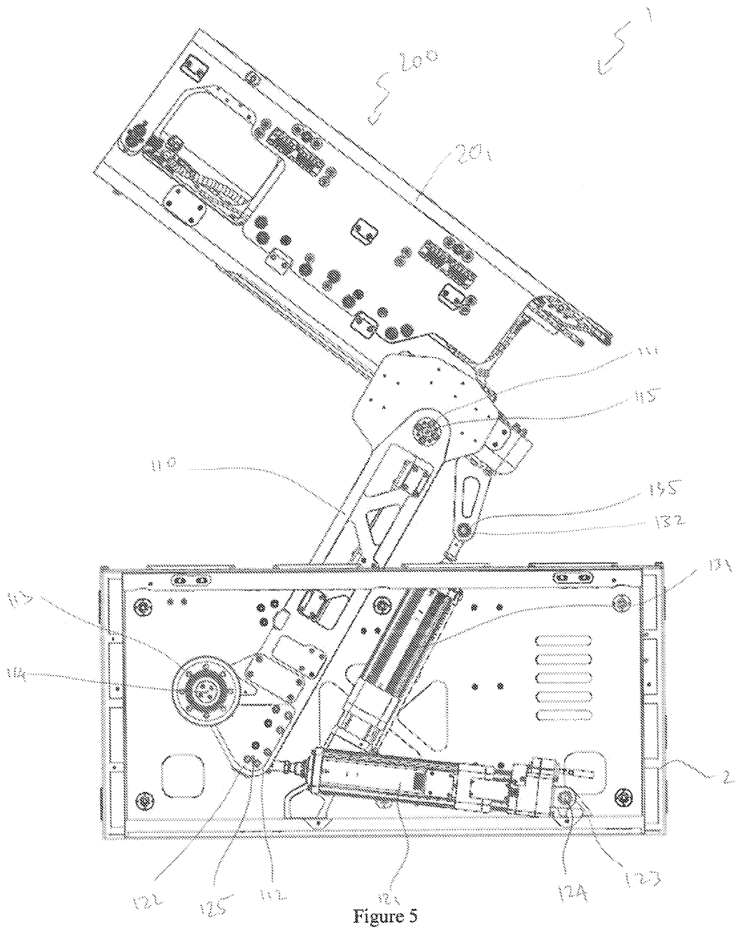

Referring now to FIGS. 1 to 6, there is shown a deployment apparatus 1 comprising a deployment mechanism 100 and a deployable module 200, wherein the deployable module 200 is moveable between a stowed position within a housing 2 (as best shown in FIG. 1) and a deployed position at least partially outside the housing 2 (as best shown in FIG. 2). The deployment mechanism 100 comprises a deployment member 110 pivotally connected with respect to the housing 2 and having a first end 111 pivotally connected with respect to the deployable module 200. The deployment mechanism 100 further comprises a lifting arrangement 120 configured to adjust an angle of the deployment member 110 with respect to the housing 2. The deployment member 110 is configured to be moved between a stowed position, where the angle between the deployment member 110 and the housing 2 is at a minimum, and a deployed position, where the angle between the deployment member 110 and the housing 2 is at a maximum.

It can be seen that the deployment member 110 is pivotally connected with respect to the housing 2 about a first axis 114 positioned at an intermediate portion of the deployment member 110 between first and second ends 111, 112 of the deployment member 110, where the distance between the first end 111 and the first axis 114 is greater than the distance between the second end 112 and the first axis 114, the reason for which will be explained in further detail below. It can also be seen that the second end 112 of deployment member 110 is pivotally connected with respect the deployable module 200 via a second axis 115.

The lifting arrangement 120 is in the form of a lift actuator 121, a linear actuator, pivotally connected at its first end 122 with respect to the housing 2, about a third axis 124 parallel to and spaced apart from that about which the deployment member 110 is pivotally connected with respect to the housing 2 (the first axis 114), and pivotally connected at its second end 123 with respect to the second end 112 of the deployment member about a fourth axis 125.

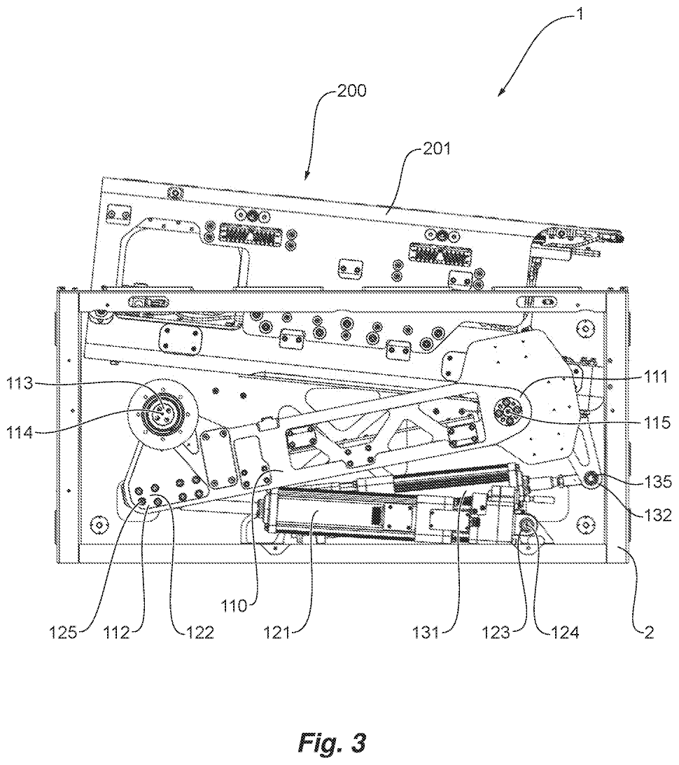

Referring now to FIGS. 3 to 5, it can be seen that retraction of the lift actuator 121 causes an increase in the angle between the deployment member 110 and the housing 2, and that extension of the lift actuator 121 causes a decrease in the angle between the deployment member 110 and the housing 2.

It will be appreciated that by virtue of the first end 111 of the deployment member 110 being further from the first axis 114 than the second end 112, that small movements of the second end 112 cause large movements at the first end 111, such that the first end 111 of the deployment member 110 and the deployable module 200 are able to be moved between their respective stowed and deployed positions with relatively small displacements of the lift actuator 121. It will further be appreciated that these distances can be adjusted to achieve a variety of different motion ratios.

Referring again to FIG. 2, it can be seen that the deployment mechanism 100 further comprises a tilting arrangement 130 in the form of a tilt actuator 131, another linear actuator, pivotally connected at its first end 132 with respect to the housing about a fifth axis 134 parallel to and spaced apart from the first axis 114, and pivotally connected at its second end 133 with respect to the deployable module 200 about a sixth axis 135 parallel to and spaced apart from that about which the deployment member 110 is pivotally connected with respect to the deployable module 200 (the second axis 115).

It will be appreciated that when the length of the tilt actuator 131 is maintained, the deployment member 110, deployable module 200 and tilt actuator 131 collectively define a four bar linkage arrangement, allowing the deployable module 200 to be raised out of the housing 2 to its deployed position and lowered back in to the housing 2 to its stowed position, as illustrated in FIGS. 3 to 5.

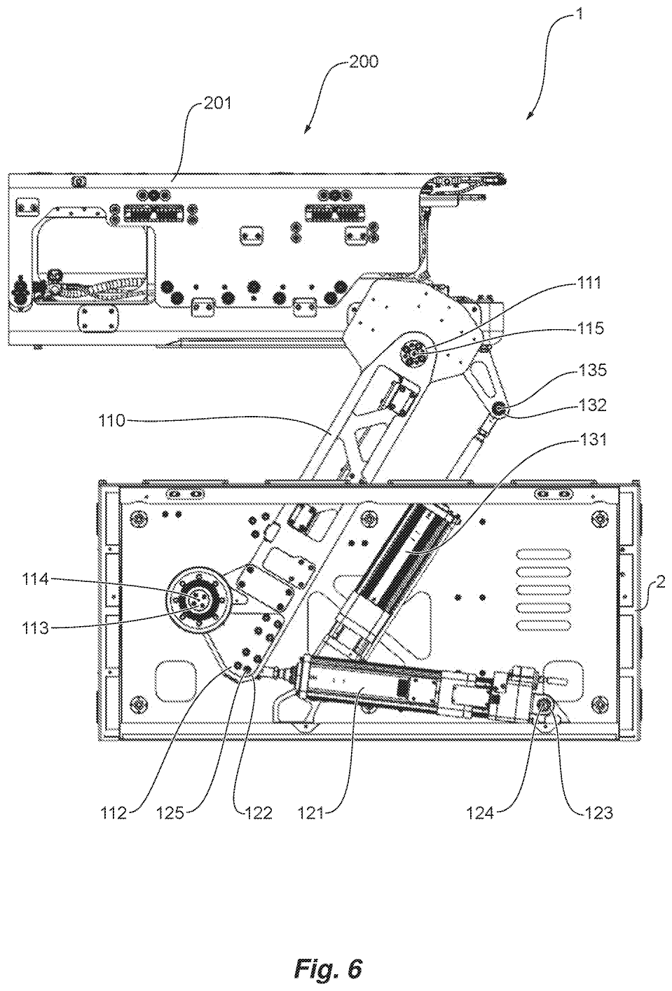

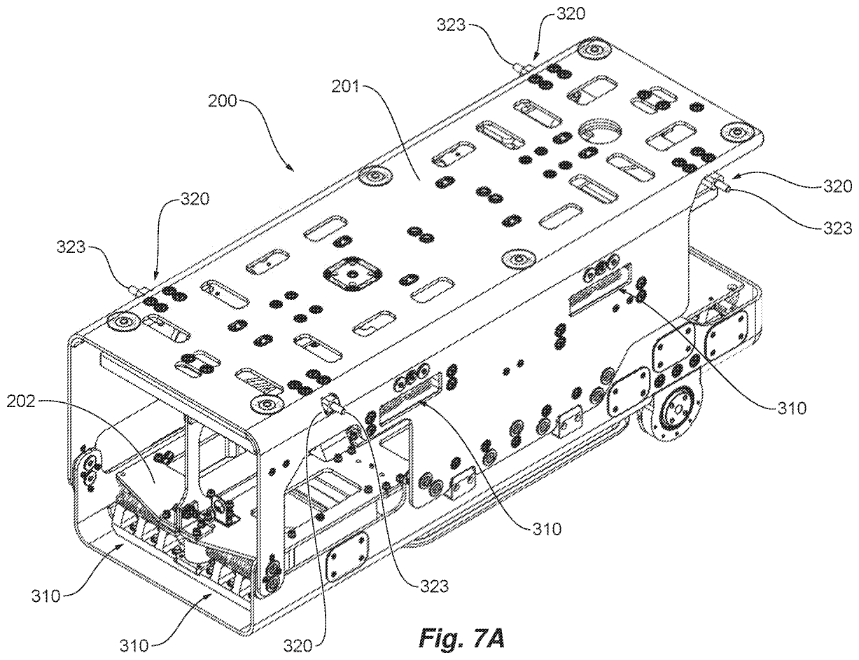

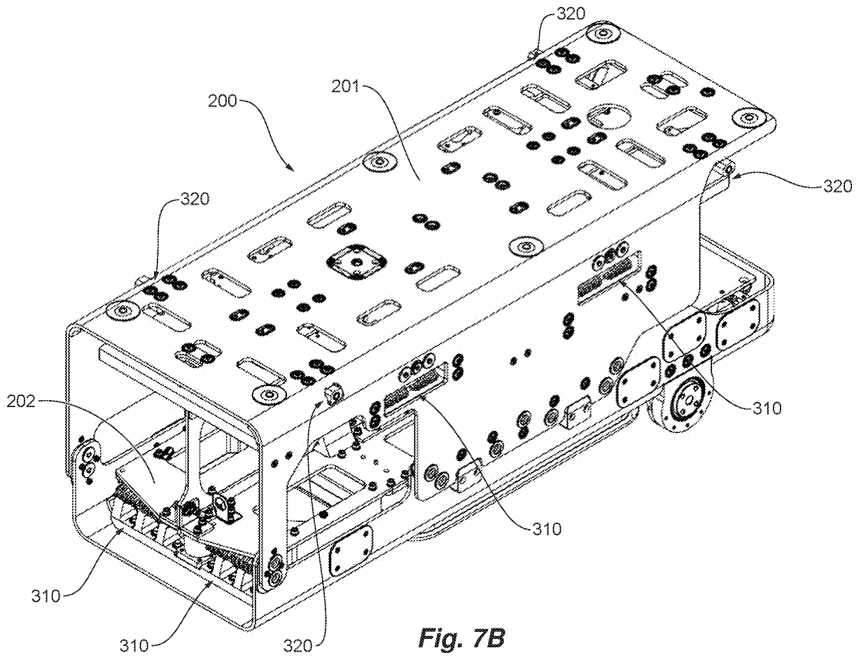

The length of the tilt actuator 131 is configured to be increased or decreased in order to adjust a tilt angle of the deployable module 200, where FIG. 6 shows the deployable module 200 at a minimum tilt angle of 0 degrees with respect to the housing (corresponding to full extension of the tilt actuator 131) and FIG. 7 shows the deployable module 200 at a maximum tilt angle of 37 degrees with respect to the housing (corresponding to full retraction of the tilt actuator 131). While in the embodiment shown, the minimum and maximum tilt angles are 0 and 37 degrees respectively, it will be appreciated that these ranges are just an example and that smaller and larger tilt angles would also be achievable through further extension and retraction of the tilt actuator 131.

It will be appreciated that the distance between the fifth and sixth axes 134, 135 can achieve large changes in angle for a small change of tilt actuator 131 length. It will further be appreciated that these distances can be adjusted to achieve a variety of different motion ratios.

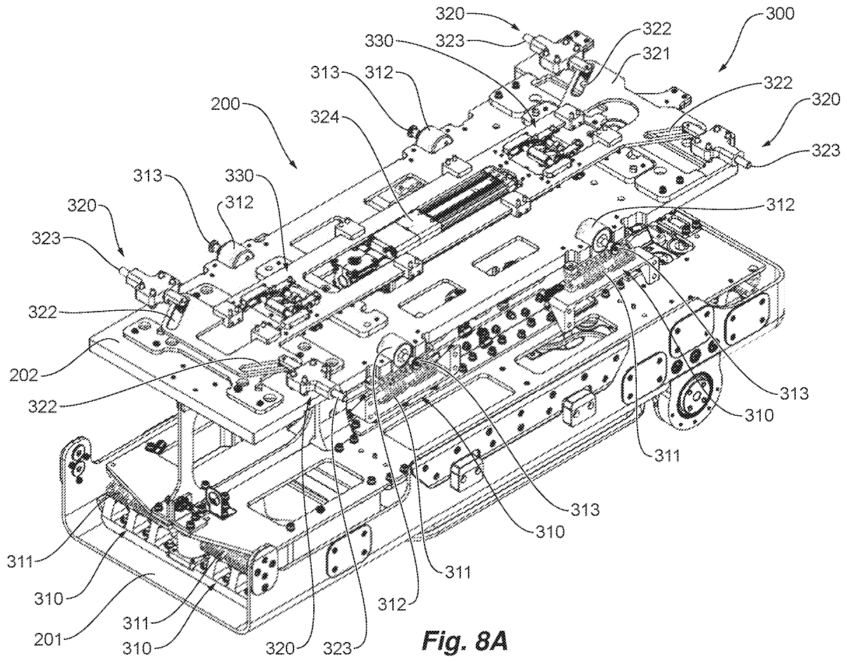

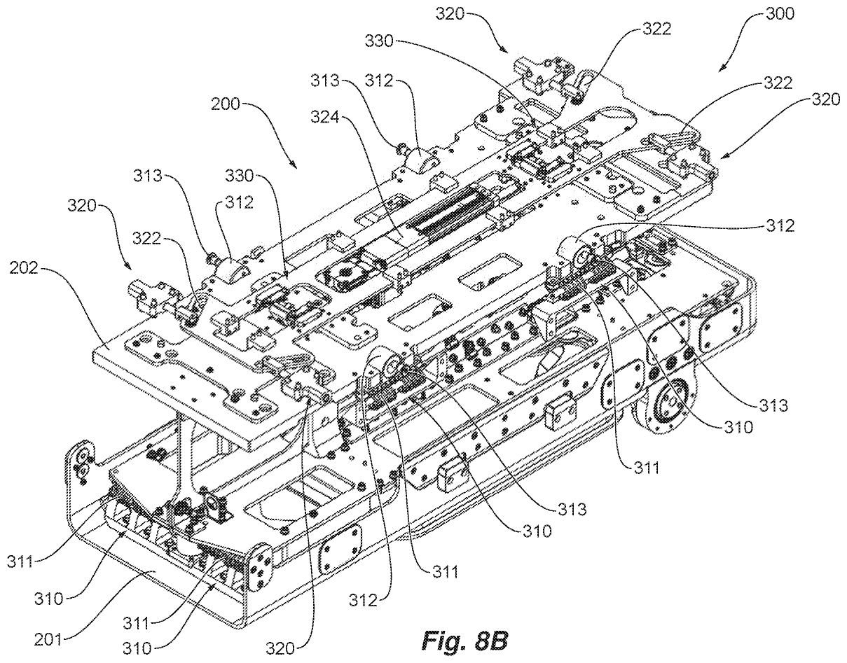

With reference to FIGS. 7a to 8b, the deployable module 200 comprises a rigid body (or outer housing) 201 (to which the deployment member 110 and second linear actuator 131 are pivotally connected) and a damped body (or internal structure) 202 mounted with respect to the rigid body by a damping arrangement 310. It will be appreciated that the damped body 202 is configured to house/contain/support a variety of systems, including but not limited to weapon and sensor systems, such as missile launchers and camera pods.

The damping arrangement 310 is a two-stage design, configured to be sufficient for a variety of vibration and shock load cases. The first stage of the damping arrangement comprises a plurality of wire rope isolators 311 (in this case eight), each connected to the rigid body and configured to attenuate vibration loads resulting from transport and vehicle driving. These would typically be designed to the allowable limits specified for any components carried by the deployable module. The second stage of the damping arrangement comprises a plurality of shock pins 313 (in this case six) mounted with respect to the rigid body 201 and a plurality of corresponding bump stop bushings 312 made from a material such as rubber or polyurethane, each connected to the damped body 202. When the damping arrangement 310 experiences high deflection shock events, the bushings 312 are configured to engage their corresponding shock pin 313. The bushings 312 are stiffer than the wire rope isolators 311 and will limit deformations, while still attenuating the load transfer to the damped body 202.

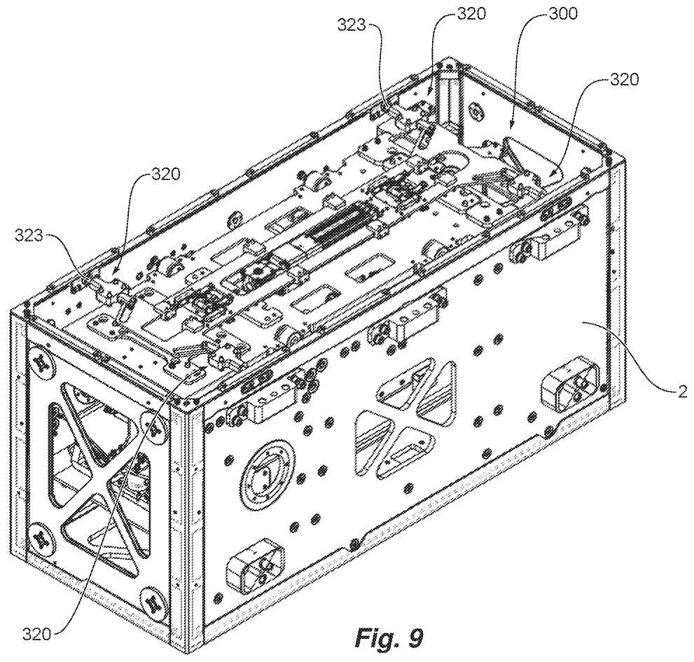

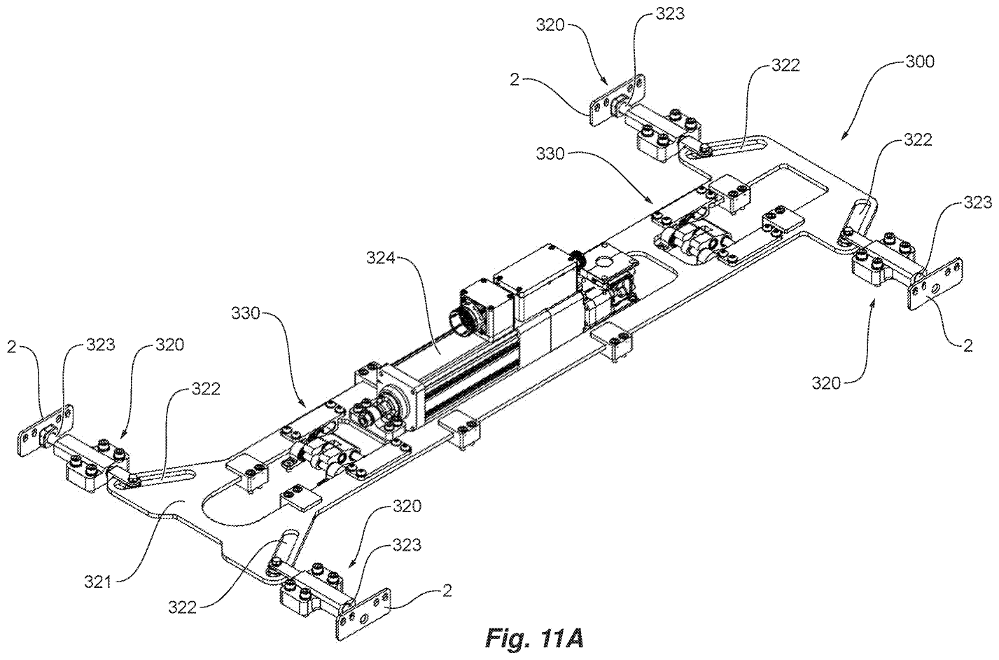

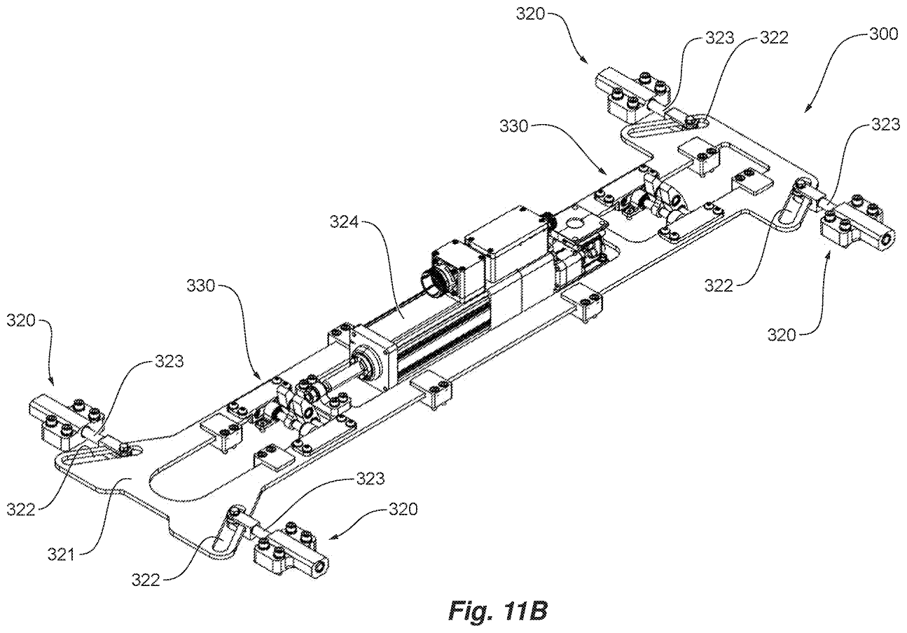

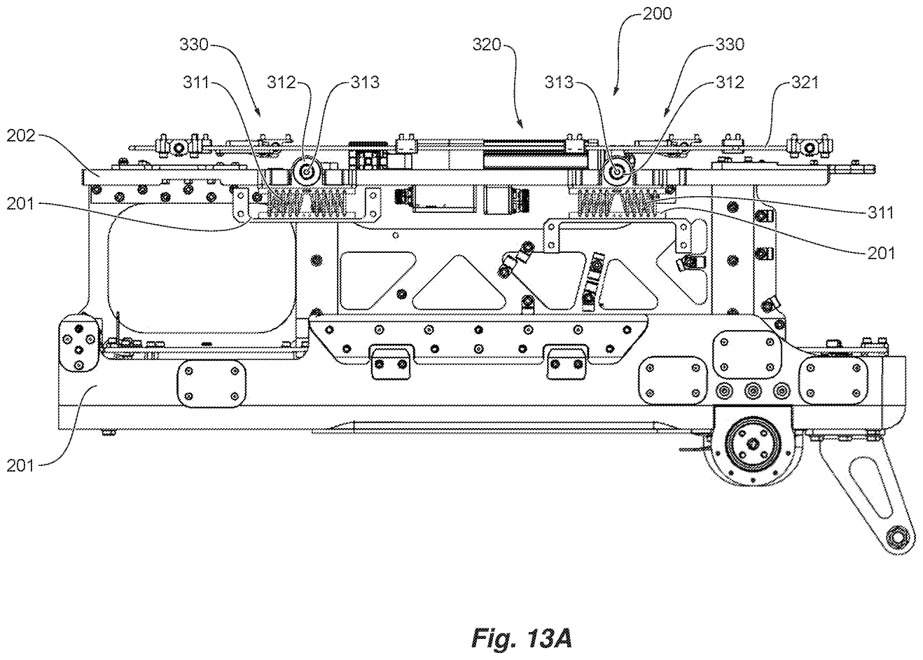

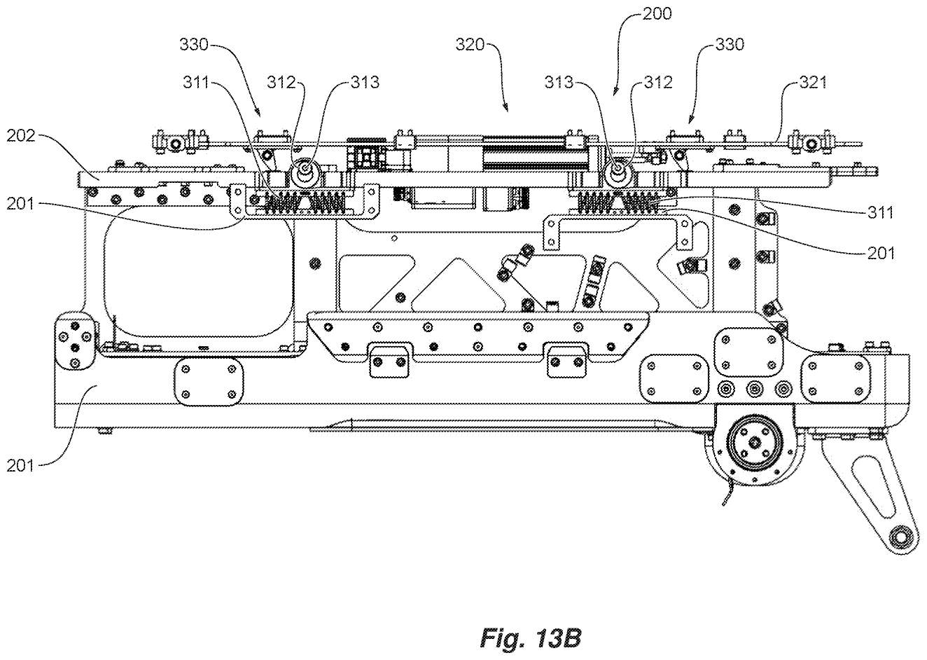

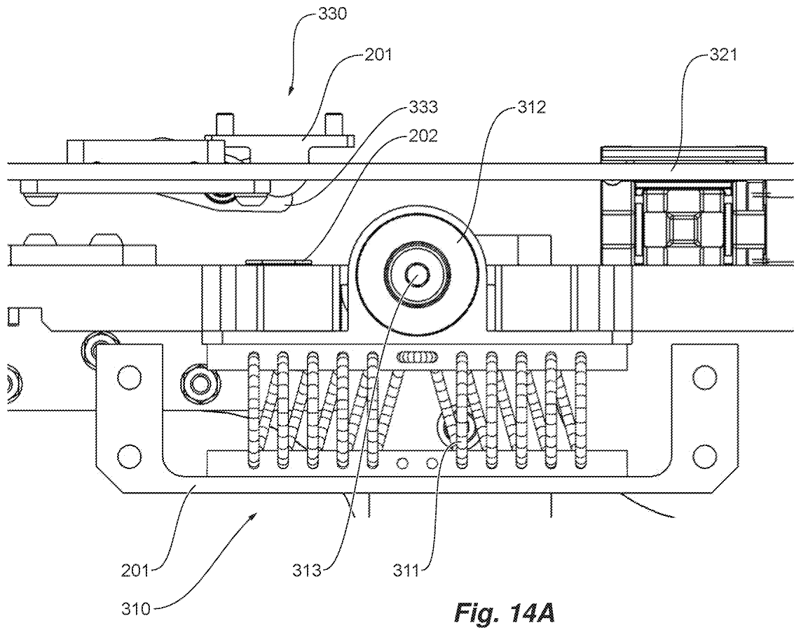

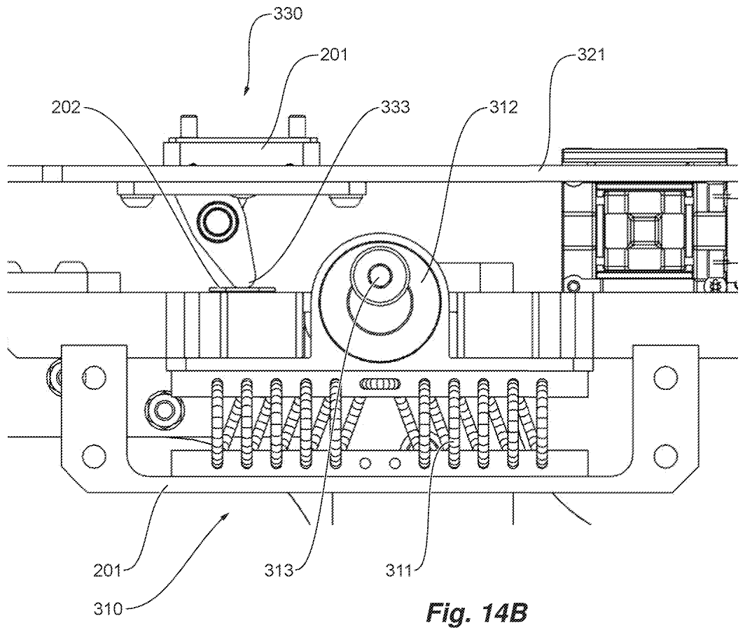

With reference to FIGS. 7a to 14b, it can be seen that the deployment apparatus 1 further comprises a locking arrangement 300 configured to lock and unlock two inversely dependent systems, being a travel lock 320 and a damper lock 330. This is achieved by actuating a lock actuator 324, another linear actuator, and a carriage 321 which converts the direction of the linear motion of the lock actuator 324 to the desired direction for the travel and damper locks 320, 330. In a first state (shown in FIGS. 7a, 8a, 9, 10, 11a, 12a, 13a and 14a) the travel lock 320 is locked and the damper lock 330 is unlocked, in a second state (shown in FIGS. 7b, 8b, 11b, 12b, 13b and 14b) the travel lock 320 is unlocked and the damper lock 330 is locked.

The travel lock 320 is configured to ensure that regardless of transport shocks, mistaken/faulty control, or powered state, the deployable module 200 remains stowed within the housing 2 and will not be deployed, even partially, without deliberate unlocking of the travel lock 320. In the embodiment shown, this is implemented by means of four laterally actuated pins 323 which extend from the deployable module 200 into the housing 2 when stowed. When deployment is required, the pins 323 are retracted and the deployable module 200 is allowed to deploy.

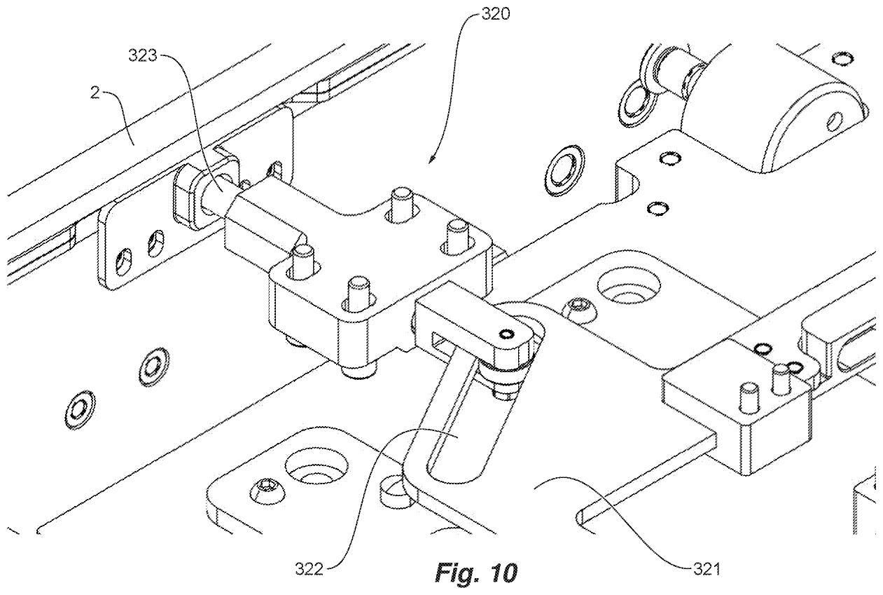

With reference to FIG. 10, it can be seen that the pins 323 extend into metallic inserts 3 provided in the housing 2. It will be appreciated that a degree of clearance may be provided between the pins 323 and the inserts 3 to allow for amounts of relative movement between the deployable module 200 and the housing 2. In an alternative form, the housing may instead be provided with bushings (not shown) for the pins 323 to extend into. It will be appreciated that by providing bushings, component wear can be improved.

Simultaneous actuation of the four pins 323 is achieved through use of the carriage 321 moveable between a first position (corresponding to the first state and full retraction of the lock actuator 324) and a second position (corresponding to the second state and full extension of the lock actuator 324).

With reference to FIGS. 8a to 10, it can be seen that the carriage 321 comprises four lock pin slots 322, angled with respect to the direction of travel of the carriage 321 and configured to receive and retain an end of a respective travel lock pin 323. Each of the travel pins 323 are also constrained to move in a direction perpendicular to that of the carriage 321, where it will be appreciated that by virtue of the angle of the lock pin slots 322, that movement of the carriage 321 from the first position to the second position causes a retraction of the travel lock pins 323 and movement of the carriage 321 from the second position to the first position cause an extension of the travel lock pins 323.

The damper lock 330 works by pre-deforming the damping arrangement 310 to a known and semi-rigid position. The damper lock 330 uses one or more mechanical linkage arrangements (in this case two) to convert the action of the lock actuator 324 to a combined rotation and translation of a first linkage 331. The motion of the first linkage 331 is such that a purely vertical force is applied to the damped body 202, such that the bushings 312 are preloaded against their respective shock pins 313 as best shown in FIGS. 8b, 13b and 14b. Once in contact and preloaded, the damped body 202 is held in place by friction which is sufficient to ensure a fixed and reproducible position each time the damper lock 330 is actuated.

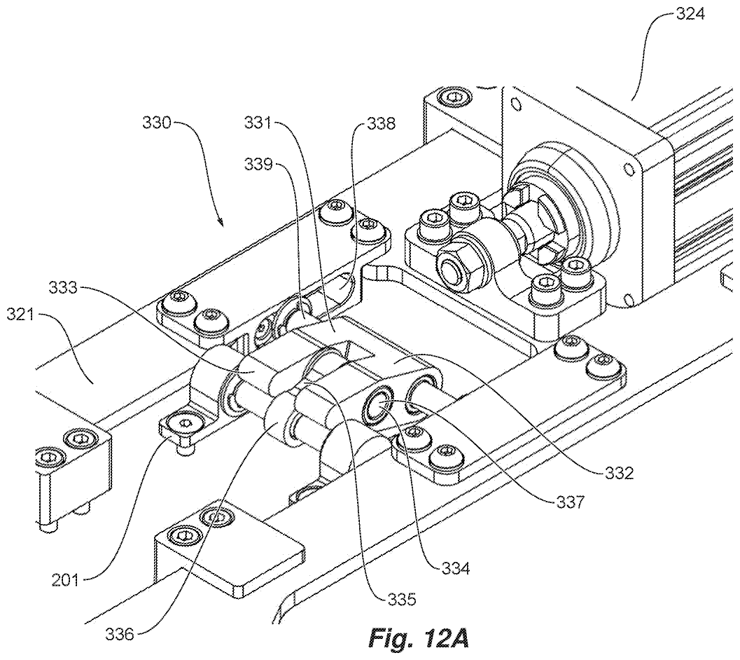

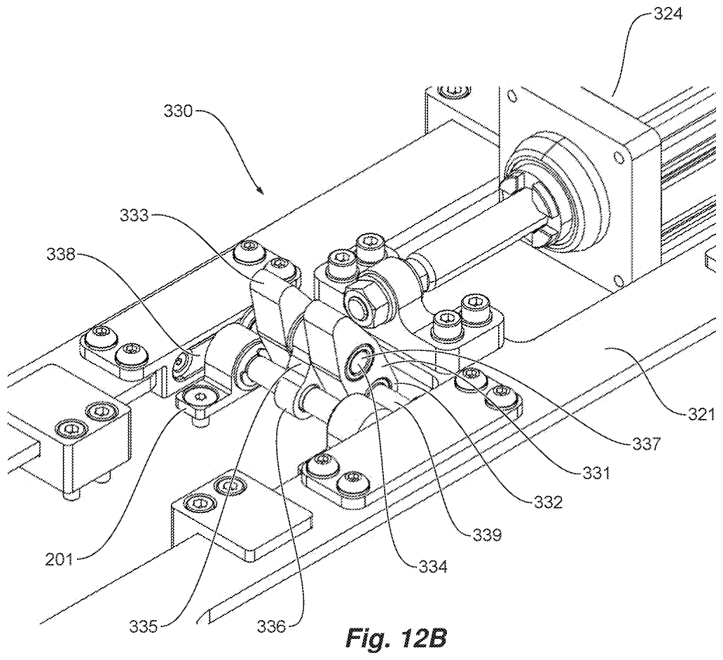

As best shown in FIGS. 12a and 12b, each mechanical linkage arrangement is a variation of what is sometimes referred to as a Scott Russell mechanism, comprising a first and second linkage 331, 335, where the first linkage 331 is double the size of the second linkage 335 and is connected to a first end 336 of the second linkage 335 by its midpoint 334, a first end 332 of the first linkage 331 is pivotally connected with respect to the carriage 321, and a second end 337 of the second linkage 335 is pivotally connected with respect to the rigid body 201. It will be appreciated that by virtue of this relationship, that as the carriage 321 is moved towards the first position, the second end 333 of the first linkage 331 is moved away from the damped body 202 to a position as shown in FIGS. 12a, 13a and 14a, and as the carriage 321 is moved towards the second position, the second end 333 of the first linkage 331 is moved toward the damped body 202, where at the carriage's 321 second position the first linkage 331 bears against the damped body 202 causing the above described preloading of the damper bushings 312 (as shown in FIGS. 12b, 13b and 14b).

The damper lock 330 is configured such that movement of the carriage 321 does not immediately translate to movement of the first linkage 331. As can be seen in FIGS. 12a and 12b, the carriage 321 comprises a pair of linkage slots 338 within which a pin 339 connected to the first end 332 of the first linkage 331 is able to translate. It will be appreciated that the length of the linkage slots 338 is less than the length of travel between the first and second position of the carriage 321, and therefore movement of the carriage 321 between its first and second positions does not affect movement of the first linkage 331 until an end of the slot bears against the pin. It will be appreciated that by providing this feature that the timing of the actuation of the travel and damper locks can be varied, all while using the single lock actuator 324.

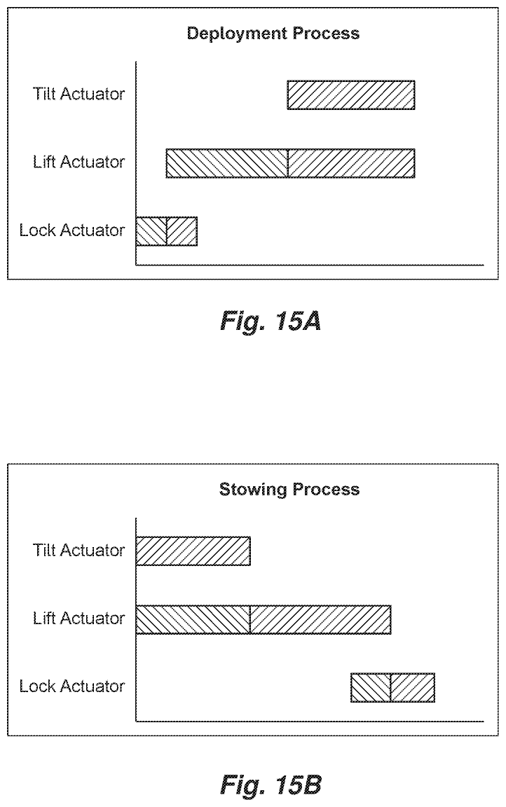

Referring now to FIGS. 15a and 15b where examples of deployment and stowing timing sequences are illustrated respectively.

Firstly, with reference to FIG. 15a, it will be appreciated that the deployed module 200 starts in a stowed state where the lift actuator 121 is fully extended, the tilt actuator 131 is at an intermediate stowed position and the locking arrangement 300 is in its first state with the travel lock 320 active and the damper lock 330 inactive. When deployment starts, the first phase of the deployment sequence requires the lock actuator 324 to extend to a point where the travel lock pins 323 are retracted from the housing 2. Once the travel lock pins 323 have been retracted the lift actuator 121 can then begin to retract causing the angle between the deployment member 110 and the housing 2 to increase, and the deployable module 200 to raise out of the housing 2. At the same time, the lock actuator 324 continues to extend to its second state, where the damper lock 330 has been locked. It will be appreciated that once the travel lock pins 323 have been sufficiently retracted, retraction of the lift actuator 121 can begin, without needing to wait for the damper lock 330 to be locked. The lift actuator 121 continues to retract until an intermediate position (in this case 48% of its movement) wherein the deployable module 200 has sufficiently cleared the housing, and the tilt actuator 131 can be extended or retracted if required so as to achieve the desired tilt angle of the deployable module 200 once the lift actuator 121 is fully retracted.

With reference to FIG. 15b, it will be appreciated that the deployed module 200 starts in a fully deployed state with the lift actuator 121 fully retracted, the tilt actuator 131 at a length corresponding to a variety of possible tilt angles and the locking arrangement 300 in its second state with the travel lock 320 inactive and the damper lock 330 active. When stowing starts, the first phase requires the tilt actuator 131 to extend or retract as required to the intermediate stowed position. At the same time, the lift actuator 121 begins to extend, reducing the angle between the deployment member 110 and the housing 2 and lowering the deployable module 200 toward the housing 2. Extension of the lift actuator 121 continues, until such point that the lock actuator 324 begins to extend, such that the time at which the lift actuator 121 has fully extended, and the deployable module 200 has fully stowed within the housing 2, the travel lock pins 323 begin to extend into the housing 2. The lock actuator 324 will then continue to extend until such time that the damper lock 330 is unlocked.

It will be appreciated that by overlapping the timing of the actuation of the respective lift, tilt and lock actuators 121, 131, 324 that optimum deployment time can be achieved while avoiding potential clashes between moving components. It will also be appreciated that the lock and lift actuator 324, 121 timing sequences shown, stay constant for any deployment stowage case, however the tilt actuator 131 process will be altered depending on the desired tilt angle of the deployable module 200.

The three actuators 121, 131, 324 are also intended to be manually operated in the event of power failure or damage to control systems. In one form (not shown) power or hand tools are able to be used to manually drive respective sockets, hex drives, or the like located on or at externally accessible locations of the apparatus 1, which are connected to their respective actuator via drive transfer means such as flexible drive members, drive shafts, gearboxes or the like, which enable the power or hand tools to manually operate each of the actuators.

It will be appreciated that the above described apparatus delivers a number of advantageous outcomes, including and not limited to its speed and accuracy of deployment delivered by separate lift and tilt actuators; its ability to selectively damp/un-damp and simultaneously lock/un-lock its travel lock, delivered by its combined travel and damper lock; its modularity, enabling a quick change out of the apparatus from a vehicle, reducing equipment downtime for servicing; its size, taking up minimal space on a vehicle platform where space is always at a premium; and its shape being a box shape ideal for packing spare units in crates and containers for deployment.

While in the embodiment shown and described, the lift, tilt and lock actuators are extended and retracted to achieve various states, it will be appreciated that their direction of extension or retraction could be modified to achieve the same outcome.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A deployment apparatus comprising a deployment mechanism and a deployable module, wherein the deployable module is moveable between a stowed position within a housing and a deployed position at least partially outside the housing, wherein the deployment mechanism comprises independent lift and tilt arrangements, wherein the lift arrangement controls the elevation of the deployable module relative to the housing and the tilt arrangement controls the relative tilt angle of the deployable module relative to the housing.

2. The deployment apparatus as claimed in claim 1, wherein the deployment mechanism further comprises a deployment member pivotally connected with respect to the housing and a first end pivotally connected with respect to the deployable module, wherein the lift arrangement is configured to adjust the angle of the deployment member between stowed and deployed positions with respect to the housing, such that in the stowed position, the deployment member is at a minimum angle and in the deployed position, the deployment member is at a maximum angle.

3. The deployment apparatus as claimed in claim 2, wherein the lift arrangement comprises a first linear actuator, pivotally connected at its first end with respect to the housing, about an axis parallel to and spaced apart from that about which the deployment member is pivotally connected with respect to the housing, and pivotally connected at its second end with respect to the deployment member, such that retraction and extension of the first linear actuator causes a respective increase and decrease in the angle between the deployment member and the housing.

4. The deployment apparatus as claimed in claim 3, wherein the tilt arrangement comprises a second linear actuator, pivotally connected at its first end with respect to the housing, about an axis parallel to and spaced apart from both the axis that the deployment member and first linear actuator rotate with respect to the housing, and pivotally connected at its second end with respect to the deployable module, about an axis parallel to and spaced apart from that about which the deployment member is pivotally connected with respect to the deployable module, such that retraction and extension of the second linear actuator causes a respective decrease and increase in the angle between the deployable module and the housing.

5. The deployment apparatus as claimed in claim 1, wherein the deployable member comprises a rigid body and a damped body mounted with respect to the outer body by a damping arrangement configured to isolate the damped body from vibration and shock events.

6. The deployment apparatus as claimed in claim 5, wherein the damping arrangement comprises a plurality of wire rope isolators separating the damped structure from the outer housing.

7. The deployment apparatus as claimed in claim 6, wherein the damping arrangement further comprises a plurality of damper bushings mounted with respect to the damped body and a plurality of shock pins mounted with respect to the rigid body, wherein in the event of a shock event, one or each of the bushings will engage a respective shock pin.

8. The deployment apparatus as claimed in claim 7, wherein the damping arrangement further comprises a locking arrangement for the deployable module, the locking arrangement configured to selectively preload the damping arrangement by preloading each of the compliant bushings against their respective shock pins.

9. The deployment apparatus as claimed in claim 8, wherein the locking arrangement is further configured to selectively prevent deployment of the deployable module from the housing.

10. The deployment apparatus as claimed in claim 8, wherein the locking arrangement is configured to achieve two states, where in a first state, the deployment of the deployable module is prevented, and the damper is not preloaded, and in a second state, deployment of the deployable module is allowed and the damper is preloaded.
